(19) United States
(12) Patent Application Publication
(10) Pub. No.: US 2019/0342064 A1
(43) Pub. Date: Nov. 7, 2019

(54) FULL DUPLEX TRANSMISSION SYSTEM

(71) Applicant: QUALCOMM Incorporated, San Diego, CA (US)

(72) Inventors: Bin Tian, San Diego, CA (US); Sameer Vermani, San Diego, CA (US); Lin Yang, San Diego, CA (US); Lochan Verma, San Diego, CA (US); George Cherian, San Diego, CA (US); Alfred Asterjadhi, San Diego, CA (US); Abhishek Pramod Patil, San Diego, CA (US)

(21) Appl. No.: 16/390,702

(22) Filed: Apr. 22, 2019

Related U.S. Application Data
(60) Provisional application No. 62/668,149, filed on May 7, 2018.
(60) Provisional application No. 62/692,330, filed on Jun. 29, 2018.

(51) Int. Cl. H04L 5/14; H04L 5/00; H04B 14/02; H04B 1/56; H04B 7/0413; H04B 7/06

(52) U.S. Cl. CPC H04L 5/1423; H04L 5/0058; H04B 7/0669; H04B 1/56; H04B 7/0413; H04B 14/026

(57) ABSTRACT

Aspects of the present disclosure relate to a wireless device including one or more processors and a memory storing processor-readable instructions that, when executed by the one or more processors, causes the wireless device to perform operations. The operations include receiving a first message indicating a reuse transmission opportunity associated with a downlink transmission from a first device to a second device. The operations further include determining to participate in the reuse transmission opportunity based at least in part on the downlink transmission. The operations further include, during the reuse transmission opportunity, transmitting uplink communications to the first device concurrently with the downlink transmission from the first device to the second device in the same frequency channel.

### PRIORITY APPLICATIONS

This patent application claims priority to the following U.S. Provisional patent applications 62/668,149 (Attorney Docket No. 182870P1), entitled “FULL DUPLEX TRANSMISSION SYSTEM” and filed on May 7, 2018; and 62/692,330 (Attorney Docket No. 182870P2), entitled “FULL DUPLEX TRANSMISSION SYSTEM” and filed on Jun. 29, 2018. The disclosures of the priority applications are incorporated by reference in this patent application.

### TECHNICAL FIELD

This disclosure relates generally to wireless communications, and more specifically, to coordinating transmissions between a set of devices to enable a full duplex transmission session at one or more of the devices.

### BACKGROUND

A wireless local area network (WLAN) may be formed by one or more access points (APs) that provide a shared wireless communication medium for use by one or more client devices, also referred to as stations (STAs). The basic building block of a WLAN conforming to the IEEE 802.11 family of standards is a Basic Service Set (BSS), which is managed by an AP that serves one or more STAs. A STA may wirelessly connect with an AP and exchange messages with the AP. The AP may also provide a gateway for the STA to wirelessly access other networks (e.g., either a wired network or a separate wireless network), such as the Internet.

The AP and STAs in a WLAN may each operate in a half-duplex operational mode. In a half-duplex mode, an individual device can transmit signals and receive signals but may not transmit and receive signals simultaneously. A full duplex operational mode would allow an individual device to transmit and receive signals simultaneously in the same frequency channel, which could improve overall throughput in some networks.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Some aspects of the present disclosure relate to a method for wireless communication. The method includes receiving a first message indicating a reuse transmission opportunity associated with a downlink transmission from a first device to a second device. The method further includes determining to participate in the reuse transmission opportunity based at least in part on the downlink transmission. The method further includes, during the reuse transmission opportunity, transmitting uplink communications to the first device concurrently with the downlink transmission from the first device to the second device in the same frequency channel.

Some further aspects of the present disclosure relate to a wireless device including one or more processors and a memory storing processor-readable instructions that, when executed by the one or more processors, causes the wireless device to perform operations. The operations include receiving a first message indicating a reuse transmission opportunity associated with a downlink transmission from a first device to a second device. The operations further include determining to participate in the reuse transmission opportunity based at least in part on the downlink transmission. The operations further include, during the reuse transmission opportunity, transmitting uplink communications to the first device concurrently with the downlink transmission from the first device to the second device in the same frequency channel.

Some further aspects of the present disclosure relate to a method for wireless communication. The method includes transmitting a first message indicating a reuse transmission opportunity associated with an uplink transmission from a first device. The method further includes receiving a response message from a second device, the response message including a request to participate in the reuse transmission opportunity. The method further includes selecting the second device to participate in the reuse transmission opportunity based at least in part on the response message. The method further includes, during the reuse transmission opportunity, receiving the uplink transmission from the first device while concurrently transmitting downlink communications to the second device in the same frequency channel.

Some further aspects of the present disclosure relate to a wireless device including one or more processors and a memory storing processor-readable instructions that, when executed by the one or more processors, causes the wireless device to perform operations. The operations include transmitting a first message indicating a reuse transmission opportunity associated with an uplink transmission from a first device. The operations further include receiving a response message from a second device, the response message including a request to participate in the reuse transmission opportunity. The operations further include selecting the second device to participate in the reuse transmission opportunity based at least in part on the response message. The operations further include, during the reuse transmission opportunity, receiving the uplink transmission from the first device while concurrently transmitting downlink communications to the second device in the same frequency channel.

Some further aspects of the present disclosure relate to a non-transitory computer-readable storage medium comprising instructions that, when executed by one or more processors of an apparatus, cause the apparatus to perform operations. The operations include receiving a first message indicating a reuse transmission opportunity associated with a downlink transmission from a first device to a second device. The operations further include determining to participate in the reuse transmission opportunity based at least in part on the downlink transmission. The operations further include, during the reuse transmission opportunity, transmitting uplink communications to the first device concurrently with the downlink transmission from the first device to the second device in the same frequency channel.

Some further aspects of the present disclosure relate to a non-transitory computer-readable storage medium comprising instructions that, when executed by one or more processors of an apparatus, cause the apparatus to perform operations. The operations include transmitting a first message indicating a reuse transmission opportunity associated with an uplink transmission from a first device. The operations further include receiving a response message from a second device, the response message including a request to participate in the reuse transmission opportunity. The operations further include selecting the second device to participate in the reuse transmission opportunity based at least in part on the response message. The operations further include, during the reuse transmission opportunity, receiving the uplink transmission from the first device while concurrently transmitting downlink communications to the second device in the same frequency channel.

Some further aspects of the present disclosure relate to a device comprising a wireless station. The wireless station includes means for receiving a first message indicating a reuse transmission opportunity associated with a downlink transmission from a first device to a second device. The wireless station further includes means for determining to participate in the reuse transmission opportunity based at least in part on the downlink transmission. The wireless station further includes means for, during the reuse transmission opportunity, transmitting uplink communications to the first device concurrently with the downlink transmission from the first device to the second device in the same frequency channel.

Some further aspects of the present disclosure relate to device comprising an access point. The access point includes means for transmitting a first message indicating a reuse transmission opportunity associated with an uplink transmission from a first device. The access point further includes means for receiving a response message from a second device, the response message including a request to participate in the reuse transmission opportunity. The access point further includes means for selecting the second device to participate in the reuse transmission opportunity based at least in part on the response message. The access point further includes means for, during the reuse transmission opportunity, transmitting downlink communications to the second device while concurrently receiving the uplink transmission from the first device in the same frequency channel.

### BRIEF DESCRIPTION OF THE DRAWINGS

The system may be better understood with reference to the following drawings and description. The components in the figures are not necessarily to scale, emphasis instead being placed upon illustrating the principles of the disclosure. Moreover, in the figures, like reference numerals designate corresponding parts throughout the different views. Aspects of the present disclosure are illustrated by way of example, and not by way of limitation, in the figures of the accompanying drawings and in which like reference numerals refer to similar elements.

FIG. 1 is a diagram illustrating an example of a wireless local area network (WLAN) deployment.

FIG. 2A is an example of a system for establishing an uplink reuse transmission in a full duplex transmission session.

FIG. 2B is an example of a system for establishing a downlink reuse transmission in a full duplex transmission session.

FIG. 3 is a diagram of a communication network including aspects of an AP configured for coordinating transmissions between a set of devices to enable a full duplex transmission session at the AP.

FIG. 4 is a diagram of a communication network including aspects of a STA configured for participating in a full duplex transmission session.

FIG. 5 is a flow diagram illustrating a process for coordinating transmissions between a set of devices to enable a full duplex transmission session.

FIG. 6 is a flow diagram illustrating a process for participating in a full duplex transmission session.

FIG. 7 is a message exchange diagram for establishing an uplink reuse transmission as part of a full duplex transmission session.

FIG. 8 is a message exchange diagram for establishing a downlink reuse transmission as part of a full duplex transmission session.

FIG. 9 is a flow diagram illustrating an example process for wireless communication according to some aspects.

FIG. 10 is a flow diagram illustrating another example process for wireless communication according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The systems and techniques described in this detailed description provide various mechanisms for coordinating transmissions between a set of devices to enable a full duplex transmission session at one or more of the devices. In some aspects, the full duplex transmission session may be performed at an access point (AP) that communicates with multiple stations (STAs). In these aspects, the AP may communicate with one or more STAs in a first direction (e.g., by receiving an uplink transmission at the AP from a STA), simultaneously with communicating with one or more different STAs in a second direction (e.g., by transmitting a downlink transmission from the AP to a STA). The STAs that communicate with the AP may each individually operate in a half-duplex mode, while the AP operates in a full duplex mode by communicating with multiple different STAs at the same time. Alternatively, in other aspects, each individual STA may be configured to operate in a full duplex mode by including hardware (e.g., multiple antennas, and multiple radio frequency transmit/receive chains) that allows the STA to transmit and receive simultaneously.

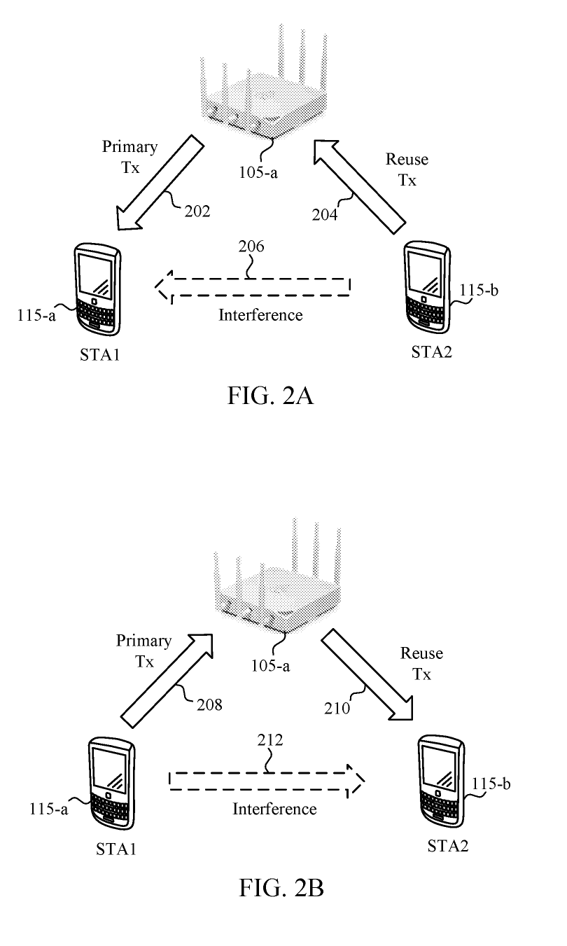

In some aspects, when a device operates in a full duplex transmission session, one of the simultaneous transmissions may be treated as a primary transmission while the other transmission is treated as a reuse transmission (or a secondary transmission). The primary transmission is a transmission involving the holder of a transmission opportunity (TXOP). The reuse transmission occurs in the opposite direction as the primary transmission. The reuse transmission may be an opportunistic transmission that may be subject to power control, duration control, and/or other possible constraints to ensure it does not interfere too heavily with the reception of the primary transmission. The devices that participate in the full duplex transmission session may communicate information, measure possible interference data, and/or coordinate transmission operations in effort to reduce the chance of the reuse transmission interfering with the primary transmission. Various aspects and mechanisms to achieve such a full duplex transmission session will be discussed in more detail below, such as in the descriptions related to FIGS. 2A, 2B, and 5-8.

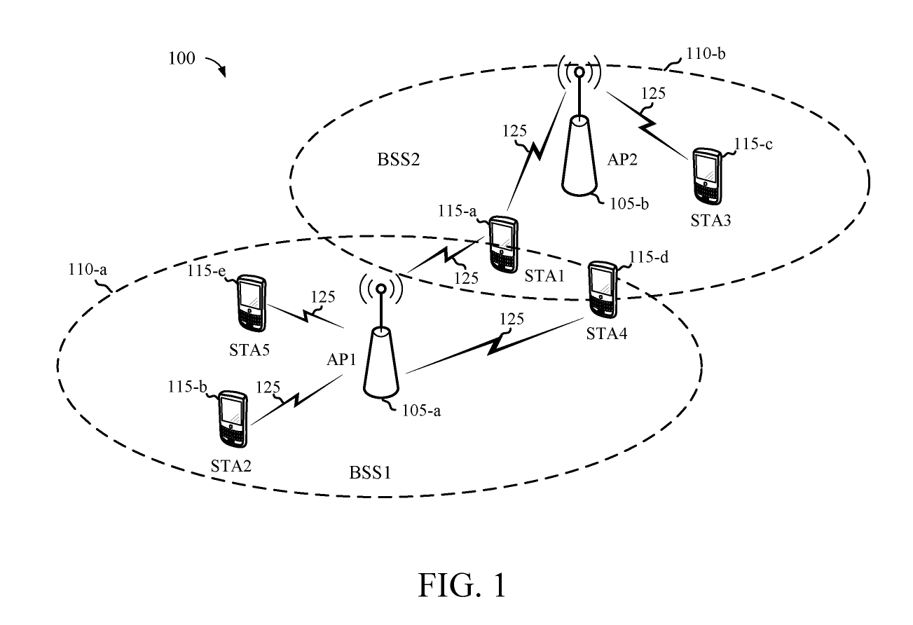

FIG. 1 is a wireless communication system 100 illustrating an example of a wireless local area network (WLAN) deployment in connection with various techniques described herein for coordinating transmissions between a set of devices to enable a full duplex transmission session at one or more of the devices. The WLAN deployment may include one or more access points (APs) and one or more wireless stations (STAs) associated with a respective AP. In this example, there are two APs deployed for illustrative purposes: AP1 105-a in basic service set 1 (BSS1) and AP2 105-b in BSS2. BSS1 and BSS2 may be identified by different BSS color indicators in communications to allow receiving devices to differentiate the source BSS of a communication according to which BSS color indicator is included in the communication. AP1 105-a is shown having multiple associated STAs (STA1 115-a, STA2 115-b, STA4 115-d, and STA5 115-e) and coverage area 110-a, while AP2 105-b is shown having multiple associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

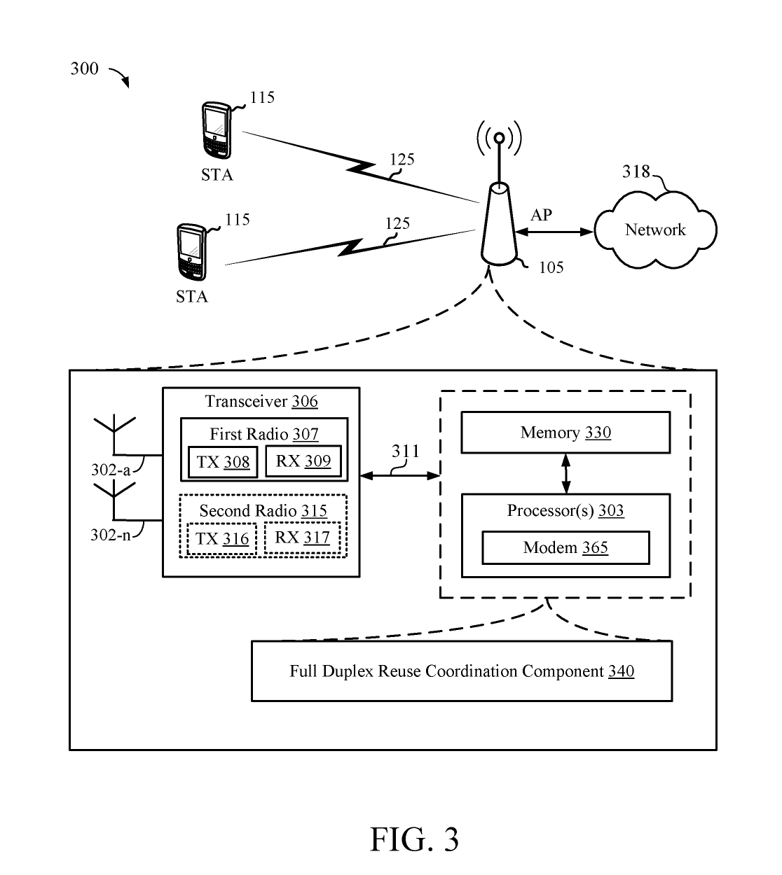

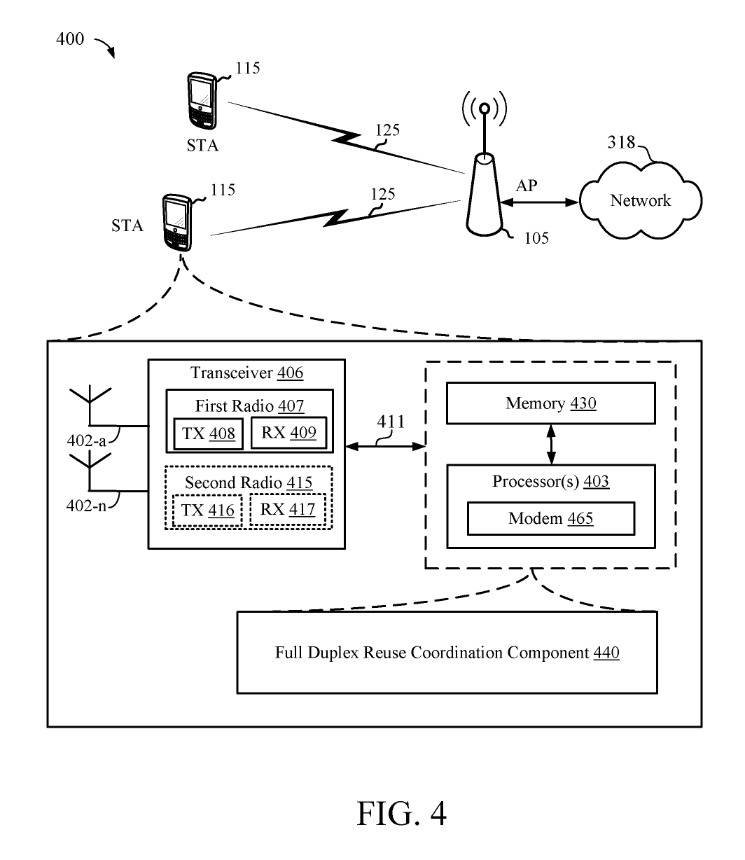

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The AP may also be a STA, such as a STA operating in an AP role. The STAs (e.g., STA1 115-a, STA2 115-b, STA3 115-c, STA4 115-d, and STAS 115-e) shown in FIG. 1, which may be fixed, non-fixed, or mobile terminals, utilize the backhaul services of their respective AP to connect to a network (see, e.g., network 318 in FIGS. 3 and 4), such as the Internet. Examples of a STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. A STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STAS 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with a STA that is within the coverage area of the AP. Communications links 125 can comprise communications channels that can enable both uplink and downlink communications. When connecting to an AP, a STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN, and other technologies used in wide area networks (WANs), cellular networks, WLANs, personal area networks (PAN)s, or other suitable networks now known or later developed.

FIG. 2A is an example of a system for establishing an uplink reuse transmission in a full duplex transmission session. In the example of FIG. 2A, an AP 105-a hosts a full duplex transmission session by establishing a first communication channel with STA 115-a and a second communication channel with STA 115-b. During this full duplex transmission session of the AP 105-a, STAs 115-a and 115-b may each be operating in a half-duplex operation mode. The full duplex transmission session of FIG. 2A includes a primary transmission 202 between the AP 105-a and STA 115-a, and a reuse transmission 204 between the AP 105-a and STA 115-b. In this example, the primary transmission 202 is a downlink transmission sent from the AP 105-a to the STA 115-a, and the reuse transmission 204 is an uplink transmission sent from the STA 115-b to the AP 105-a.

In the example of FIG. 2A, both the primary and reuse transmissions are shown as single-user (SU) transmissions. However, in other aspects, either or both of the primary and reuse transmissions may be multi-user (MU) transmissions. For example, the primary transmission may be sent from the AP 105-a to multiple STAs via a downlink (DL) orthogonal frequency-division multiple access (OFDMA) transmission, a MU multiple-input and multiple-output (MIMO) transmission, a time-division multiple access (TDMA) transmission, or another multi-user transmission format. The reuse transmission may be sent by a group of multiple STAs to the AP 105-a as an uplink (UL) OFDMA transmission, an UL MU-MIMO transmission, a TDMA transmission, or another multi-user transmission format.

When deciding whether to establish the opportunity for the reuse transmission 204, the STA 115-b or the AP 105-a may consider the possible interference 206 the reuse transmission 204 would cause to the intended reception of the primary transmission 202 at STA 115-a. If the possible interference 206 is deemed to be too high, then the STA 115-b or AP 105-a may elect to not participate in any reuse transmission that overlaps in time with the primary transmission 202. However, if the interference 206 is deemed to be within an acceptable range, then the STA 115-b or AP 105-a may decide to allow the reuse transmission 204 and use the opportunity to send uplink data from the STA 115-b to the AP 105-a.

In the full duplex transmission session of FIG. 2A, one possible constraint on the reuse transmission is to control the interference from STA2 (e.g., STA 115-b involved in the potential reuse transmission 204) to STA1 (e.g., STA 115-a involved in the primary transmission 202) to be below a threshold value (e.g., a threshold value provided to the STA 115-b from the AP 105-a), according to the following equation:

TxPowers_{STA2}−PathLoss₁₂≤InterferenceThreshold,

where TxPower_{STA2} represents the transmission power used by STA2, PathLoss₁₂ is the amount of path loss experienced between STA1 and STA2 (e.g., as measured by STA2 based on an earlier transmission from STA1), and InterferenceThreshold is based at least in part on a tolerable interreference level at STA1. The PathLoss₁₂ variable may be calculated by STA2 as:

PathLoss₁₂=TxPowers_{STA1}−RSSI_{STA2},

where TxPower_{STA1} represents the amount of power used by STA1 for a transmission (e.g., a clear-to-send (CTS) message, trigger-based message, or any other transmission) that STA2 receives and measures for the pass loss calculation, and RSSI_{STA2} represents the received signal strength indicator (RSSI) value associated with the transmission from STA1 that STA2 measures at the point the transmission is received at STA2. The RSSI value may represent the power present in a transmission when the transmission is received at the measuring device. Putting the calculations together, the determination becomes:

TxPowers_{STA2}≤(InterferenceThreshold+TxPowers_{STA1})−RSSI_{STA2}.

Other interference calculations are possible to determine qualification for the reuse transmission, but in this example, STA2 may qualify for the reuse transmission if the power it would want to use for a potential reuse transmission (TxPower_{STA2}) would be less than or equal to the interference threshold (InterferenceThreshold) plus the transmission power used by STA1 for the path loss test transmission (TxPower_{STA1}) (the combined value of InterferenceThreshold+TxPower_{STA1} may be provided to STA2 from the AP) minus the power value calculated at STA2 (RSSI_{STA2}) for the reception of the path loss test transmission sent by STA1.

FIG. 2B is an example of a system for establishing a downlink reuse transmission in a full duplex transmission session. In the example of FIG. 2B, an AP 105-a hosts a full duplex transmission session by establishing a first communication channel with STA 115-a and a second communication channel with STA 115-b. During this full duplex transmission session of the AP 105-a, STAs 115-a and 115-b may each be operating in a half-duplex operation mode. The full duplex transmission session of FIG. 2B includes a primary transmission 208 between the AP 105-a and STA 115-a, and a reuse transmission 210 between the AP 105-a and STA 115-b. In this example, the primary transmission 208 is an uplink transmission sent from the STA 115-a to the AP 105-a, and the reuse transmission 210 is a downlink transmission sent from the AP 105-a to the STA 115-b.

In the example of FIG. 2B, both the primary and reuse transmissions are shown as single-user (SU) transmissions. However, in other aspects, either or both of the primary and reuse transmissions may be multi-user (MU) transmissions. For example, the primary transmission may be sent from a group of multiple STAs to the AP 105-a as an UL OFDMA transmission, an UL MU-MIMO transmission, a TDMA transmission, or another multi-user transmission format. The reuse transmission may be sent by the AP 105-a to multiple STAs via a DL OFDMA transmission, a MU-MIMO transmission, a TDMA transmission, or another multi-user transmission format.

When deciding whether to establish the opportunity for the reuse transmission 210, the STA 115-b or the AP 105-a may consider the possible interference 212 the primary transmission 208 would cause to the intended reception of the reuse transmission 210 at STA 115-b. If the possible interference 212 is deemed to be too high, then the STA 115-b or AP 105-a may elect to not participate in any reuse transmission that overlaps in time with the primary transmission 208. However, if the interference 212 is deemed to be within an acceptable range, then the STA 115-b or AP 105-a may decide to allow the reuse transmission 210 and use the opportunity to send downlink data from the AP 105-a to the STA 115-b.

In an aspect, the AP 105-a or the STA 115-b may calculate an interference threshold usable by STA 115-b to determine whether it qualifies for participation in the reuse transmission 210 based on the potential interference from the primary transmission 208. When the interference threshold is calculated by the AP 105-a, the AP 105-a may send the interference threshold to the STA 115-b (such as in a message polling for reuse candidate STAs). The interference threshold may be calculated by the AP 105-a or the STA 115-b in a manner or format that allows the STA 115-b to determine qualification for the reuse transmission 210 by comparing the interference threshold to a power value calculated at the STA 115-b (such as an RSSI value) for the reception of a path loss test transmission sent by the STA 115-a. For example, the STA 115-b may determine if the RSSI_{STA2} value (as described above in connection with FIG. 2A) is less than or equal to the interference threshold provided by the AP 105-a (or calculated locally based on data provided by the AP 105-a).

The STA 115-b that is interested in participating in the downlink reuse transmission may feedback interference information to the AP regarding the interference situation of STA 115-b from STA 115-a. The interference information may be a measured RSSI level associated with a transmission from STA 115-a that is received at STA 115-b. Alternatively, the interference information may be a binary feedback regarding whether the interference level experienced is greater than a predetermined threshold. Providing the interference information to the AP allows the AP to decide whether the STA is qualified for the reuse transmission 210 and/or allows the AP to set its desired transmission characteristics for the reuse transmission 210. For example, the AP may use the interference information to decide the modulation and coding scheme (MCS), number of spatial streams, transmission power, or other transmission characteristics.

FIG. 3 illustrates an example wireless communication system 300 that includes multiple STAs 115 in wireless communication with at least one AP 105 connected to network 318. The STAs 115 may communicate with network 318 via AP 105. In an example, STAs 115 may transmit and/or receive wireless communication to and/or from AP 105 via one or more communication links 125. Such wireless communications may include, but are not limited to, data, audio and/or video information. In some instances, such wireless communications may include control or similar information. An AP, such as AP 105, may be configured to perform the techniques related to coordinating transmissions between a set of devices to enable a full duplex transmission session at one or more of the devices (see, e.g., FIGS. 2A, 2B, and 5-8).

In accordance with the present disclosure, AP 105 may include a memory 330, one or more processors 303 and a transceiver 306. The memory 330, the one or more processors 303 and the transceiver 306 may communicate internally via a bus 311. In some examples, the memory 330 and the one or more processors 303 may be part of the same hardware component (e.g., may be part of a same board, module, or integrated circuit). Alternatively, the memory 330 and the one or more processors 303 may be separate components that may act in conjunction with one another. The bus 311 may be a communication system that transfers data between multiple components and subcomponents of the AP 105. In some examples, the one or more processors 303 may include any one or combination of modem processor, baseband processor, digital signal processor, and/or transmit processor. The one or more processors 303 may include a modem 365. The AP 105 includes a full duplex reuse coordination component 340 for carrying out one or more methods or procedures described herein in connection with an AP. The full duplex reuse coordination component 340 may comprise hardware, firmware, and/or software and may be configured to execute code or perform instructions stored in a memory (e.g., a computer-readable storage medium). For example, the full duplex reuse coordination component 340 may be implemented by the processor 303 executing instructions stored on memory 330.

In some examples, the memory 330 may be configured for storing data that is used in connection with local applications, and/or in connection with the full duplex reuse coordination component 340 and/or one or more of any subcomponents being executed by the one or more processors 303. Memory 330 can include any type of computer-readable medium usable by a computer or processor 303, such as random-access memory (RAM), read only memory (ROM), tapes, magnetic discs, optical discs, volatile memory, non-volatile memory, and any combination thereof. In an aspect, for example, memory 330 may be a computer-readable storage medium (e.g., a non-transitory medium) that stores computer-executable code. The computer-executable code may define one or more operations or functions of the full duplex reuse coordination component 340 and/or one or more of any subcomponents, and/or data associated therewith. The computer-executable code may define these one or more operations or functions when AP 105 is using processor 303 to execute full duplex reuse coordination component 340 and/or one or more of any subcomponents. In some examples, the AP 105 may further include the transceiver 306 for transmitting and/or receiving one or more data and control signals (e.g., messages) to/from a STA. For example, the AP 105 may transmit trigger frames, request-to-send (RTS) messages, probe responses, broadcast probe responses, beacons, Fast Initial Link Setup (FILS) discovery frames, or other data or control frames. The transceiver 306 may comprise hardware, firmware, and/or software and may be configured to execute code or perform instructions stored in a memory (e.g., a computer-readable storage medium). The transceiver 306 may include one or more radios, including a radio 307 comprising a transmitter 308 and a receiver 309. The radio 307 may utilize one or more antennas 302 (e.g., antennas 302-a, . . . , 302-n) for transmitting signals to and receiving signals from a plurality of STAs. In some aspects, the transceiver 306 may include multiple radios that enable the AP 105 to operate as a multi-mode device or may enable the AP 105 to operate in a full duplex operation mode that may transmit and receive data simultaneously. In a full duplex operation mode, the AP 105 may use a first radio to transmit at a same time as a second radio 315 having a TX 316 and a RX 317 receives. Alternatively, a full duplex operation may be performed by one radio (e.g., the first radio 307) that uses the transmitter 308 and one antenna to transmit to one device (or set of devices) while the receiver 309 and a different antenna receives data from another device (or set of devices). The receiver(s) of the transceiver 306 may include one or more radio frequency components that form a receiving chain and the transmitter(s) of the transceiver 306 may include one or more radio frequency components that form a transmitting chain.

The full duplex reuse coordination component 340 may be configured to perform, alone or in combination with other components of the AP 105, at least any AP-side functions described in connection with the flow diagrams and message diagrams of FIGS. 2A, 2B, and 5-8.

FIG. 4 illustrates an example wireless communication system 400 similar to the wireless communication system 300 in FIG. 3. One or more of the STAs 115 may be configured to perform the techniques related to coordinating transmissions between a set of devices to enable a full duplex transmission session at one or more of the devices (see, e.g., FIGS. 2A, 2B, and 5-8).

In accordance with the present disclosure, a STA 115 may include a memory 430, one or more processors 403 and a transceiver 406. The memory 430, the one or more processors 403 and the transceiver 406 may communicate internally via a bus 411. In some examples, the memory 430 and the one or more processors 403 may be part of the same hardware component (e.g., may be part of a same board, module, or integrated circuit). Alternatively, the memory 430 and the one or more processors 403 may be separate components that may act in conjunction with one another. The bus 411 may be a communication system that transfers data between multiple components and subcomponents of the STA 115. In some examples, the one or more processors 403 may include any one or combination of modem processor, baseband processor, digital signal processor, and/or transmit processor. The one or more processors 403 may include a modem 465. The STA 115 includes a full duplex reuse coordination component 440 for carrying out one or more methods or procedures described herein in connection with a STA. The full duplex reuse coordination component 440 may comprise hardware, firmware, and/or software and may be configured to execute code or perform instructions stored in a memory (e.g., a computer-readable storage medium). For example, the full duplex reuse coordination component 440 may be implemented by the processor 403 executing instructions stored on memory 430.

In some examples, the memory 430 may be configured for storing data that is used in connection with local applications, and/or in connection with the full duplex reuse coordination component 440 and/or one or more of any subcomponents being executed by the one or more processors 403. Memory 430 can include any type of computer-readable medium usable by a computer or processor 403, such as random access memory (RAM), read only memory (ROM), tapes, magnetic discs, optical discs, volatile memory, non-volatile memory, and any combination thereof. In an aspect, for example, memory 430 may be a computer-readable storage medium (e.g., a non-transitory medium) that stores computer-executable code. The computer-executable code may define one or more operations or functions of the full duplex reuse coordination component 440 and/or one or more of any subcomponents, and/or data associated therewith. The computer-executable code may define these one or more operations or functions when STA 115 is using processor 403 to execute the full duplex reuse coordination component 440 and/or one or more of any subcomponents. In some examples, the STA 115 may further include the transceiver 406 for transmitting and/or receiving one or more data and control signals (e.g., messages) to/from a STA. The transceiver 406 may comprise hardware, firmware, and/or software and may be configured to execute code or perform instructions stored in a memory (e.g., a computer-readable storage medium). The transceiver 406 may include multiple radios that enable the STA 115 to operate as a multi-mode device or client. In this example, the transceiver 406 may include a first radio 407 having a transmitter (TX) 408 and a receiver (RX) 409, and a second radio 415 having a TX 416 and a RX 417 (transmitters 416 and receivers 417). The first radio 407 may be a WLAN or Wi-Fi radio and the second radio 415 may be a non-WLAN system or non-Wi-Fi system radio (e.g., an LAA radio, an LTE-U radio).

Each of the first radio 407 and the second radio 415 may utilize one or more antennas 402 (e.g., antennas 402-a, . . . , 402-n) for transmitting signals to and receiving signals from an AP. The receivers 409 and 417 may include one or more radio frequency components that form a receiving chain, and the transmitters 408 and 416 may include one or more radio frequency components that form a transmitting chain.

The full duplex reuse coordination component 440 may be configured to perform, alone or in combination with other components of the STA 115, at least the STA-side functions described in connection with the flow diagrams and message diagrams of FIGS. 2A, 2B, and 5-8.

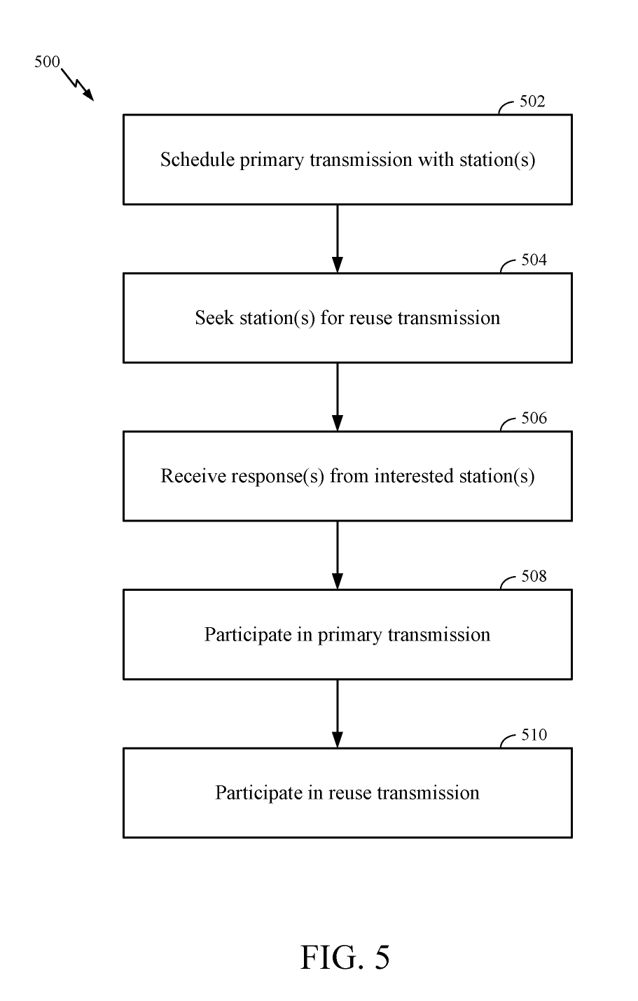

FIG. 5 is a flow diagram illustrating a process 500 for coordinating transmissions between a set of devices to enable a full duplex transmission session. In process 500, a wireless communication device, such as an AP or a STA, hosts a full duplex transmission session by communicating with one or more first devices in a primary transmission simultaneously with (e.g., at least partially overlapping in time) communicating with one or more second devices in a reuse (e.g., secondary) transmission. Note that for the remainder of the description of this flow diagram, an AP (e.g., AP 105 of FIG. 3) will be described as the wireless communication device that hosts the full duplex transmission session, although a STA (e.g., STA 115 of FIG. 4) may host the full duplex transmission session in other aspects by performing the functions of process 500 and coordinating communications for one or more other STAs and/or APs.

At block 502, the AP schedules a primary transmission with one or more STAs. For example, the AP and a STA (or group of STAs) may exchange one or more messages to set up the primary transmission and reserve a transmission opportunity (TXOP) for the primary transmission. The message exchange between the AP and the STA may provide an opportunity for the AP to trigger a measurement phase of operations, where one or more other STAs measure one or more transmission characteristics associated with messages sent by the STA scheduled for the primary transmission. The measuring STAs may then use this data later to determine qualification for a possible reuse transmission that overlaps at least a portion of the planned primary transmission.

At block 504, the AP seeks one or more stations for a possible reuse transmission that overlaps at least a portion of the planned primary transmission. For example, the AP may send one or more polling messages or trigger messages in a polling phase of operations to a group of one or more STAs to check whether any of the one or more STAs qualify for the possible reuse transmission. The qualification may be based on interference data provided by the AP, interference data measured by the STA, predetermined interference thresholds, transmission power levels, buffer status levels, buffer status thresholds, clear channel assessment (CCA) determinations, or any combination or sub-set thereof. For example, the STA receiving the polling message may compare data (e.g., an interference threshold) received in the polling message or trigger message against interference data measured locally (e.g., a power level associated with a prior transmission by the STA participating in the primary transmission).

At block 506, the AP may receive one or more responses from one or more STAs interested in participating in the possible reuse transmission. For example, one or more STAs that meet the qualification standards for reuse transmissions may send a message back to the AP in response to the polling message or trigger message to indicate a desire to participate in the reuse transmission.

At block 508, the AP participates in the primary transmission with one or more STAs (e.g., the one or more STAs that were involved in the TXOP reservation of block 502). At block 510, the AP participates in the reuse transmission with one or more STAs (e.g., the one or more STAs that responded affirmatively to the polling message or trigger message), with the reuse transmission at least partially overlapping in time with the primary transmission. In some aspects, the primary transmission is a downlink transmission sent from the AP coordinating the full duplex transmission session and the reuse transmission is an uplink transmission received by the AP (e.g., see FIG. 2A). In other aspects, the primary transmission is an uplink transmission received by the AP coordinating the full duplex transmission session and the reuse transmission is a downlink transmission sent by the AP (e.g., see FIG. 2B).

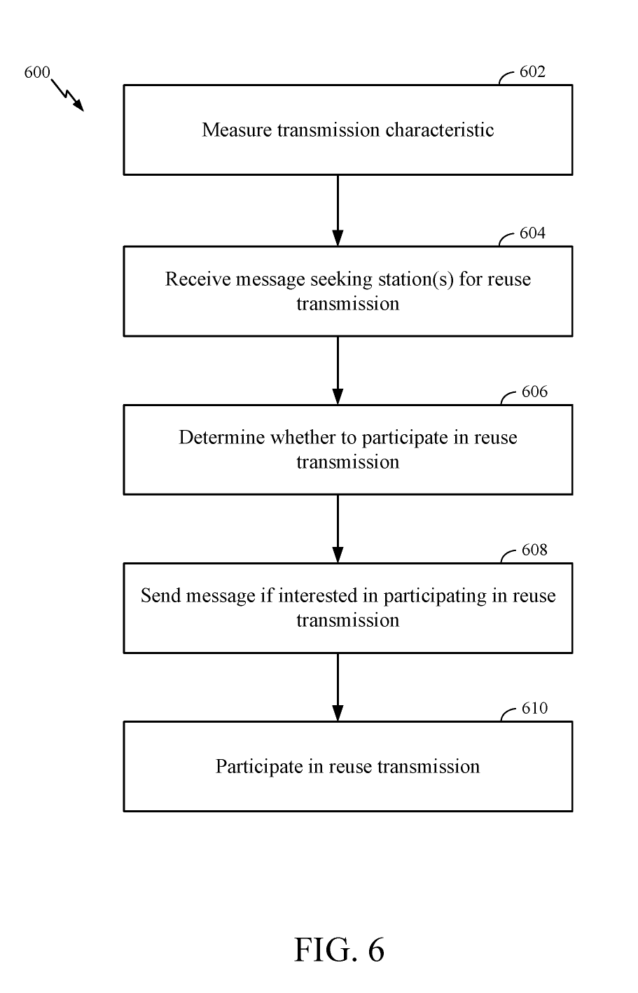

FIG. 6 is a flow diagram illustrating a process 600 for participating in a full duplex transmission session. In process 600, a wireless communication device, such as an AP or a STA, participates in a full duplex transmission session by communicating with a different device that hosts the full duplex transmission session. Note that for the remainder of the description of this flow diagram, a STA (e.g., STA 115 of FIG. 4) will be described as the wireless communication device that participates in a full duplex transmission session that is hosted by an AP (e.g., AP 105 of FIG. 3). However, in other aspects, a STA may host the full duplex transmission session for one or more other STAs and/or one or more APs that participate in the full duplex transmission session.

At block 602, a STA measures a transmission characteristic associated with a transmission received at the STA that is sent from a second device to a third device. The second device may be a second STA and the third device may be an AP. The second STA may be associated with a planned primary transmission between the second STA and the AP, where the AP may host a full duplex transmission session. The transmission characteristic measured by the STA may be an amount of power associated with the transmission at a point when the transmission is received at the measuring STA. Thus, by measuring the transmission characteristic of the transmission sent by the second STA, the measuring STA may use the measurement data along with other data (e.g., data provided by the AP) to determine a transmission path loss over the air between the two STAs and/or an amount of potential interference that would be caused by overlapping transmissions involving the two STAs.

At block 604, the STA receives a message seeking one or more STAs for a potential reuse transmission that overlaps at least a portion of a planned primary transmission. For example, the STA may receive one or more polling messages or trigger messages in a polling phase of operations from an AP that plans to host a potential full duplex transmission session. The polling messages or trigger messages may check whether any of the one or more STAs qualify for the possible reuse transmission.

At block 606, the STA determines whether it qualifies for participation in the reuse transmission (or checks whether it desires to participate). The qualification may be based on interference data provided by the AP, interference data measured by the STA, predetermined interference thresholds, transmission power levels, buffer status levels, buffer status thresholds, clear channel assessment (CCA) determinations, or any combination or sub-set thereof. For example, the STA receiving the polling message may compare data (e.g., an interference threshold) received in the polling message or trigger message against interference data measured locally (e.g., a power level associated with a prior transmission by the STA participating in the primary transmission).

If the STA qualifies for the reuse transmission and desires to participate, at block 608, the STA sends a message to the AP indicating its interest in participating in the reuse transmission. For example, the message may represent a request to participate in the reuse transmission. At block 610, the STA participates in the reuse transmission with the AP that is hosting the full duplex transmission session. In some aspects, the primary transmission is a downlink transmission sent from the AP coordinating the full duplex transmission session and the reuse transmission is an uplink transmission received by the AP (e.g., see FIG. 2A). In other aspects, the primary transmission is an uplink transmission received by the AP coordinating the full duplex transmission session and the reuse transmission is a downlink transmission sent by the AP (e.g., see FIG. 2B).

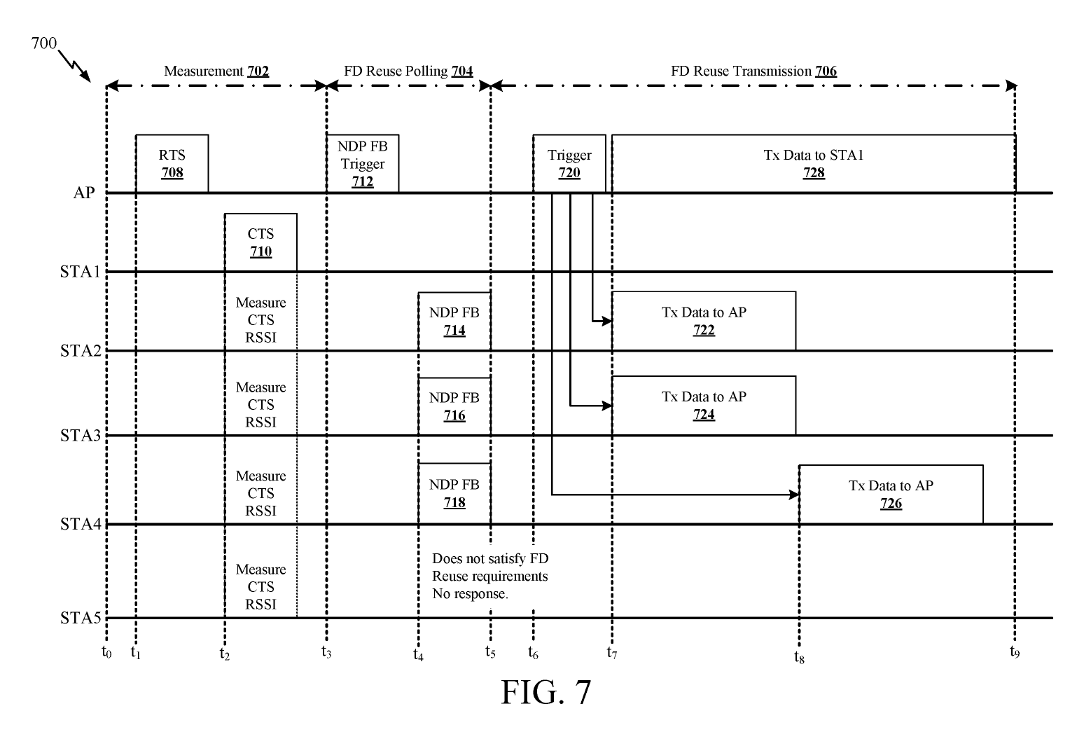

FIG. 7 is a message exchange diagram 700 for establishing an uplink reuse transmission as part of a full duplex transmission session. In the example of FIG. 7, the system includes an AP and multiple STAs (STA1-STA5). Other aspects may include any number of one or more STAs, may include multiple APs, or may include a STA acting as the AP in the message flow of FIG. 7.

The setup of the full duplex transmission session of FIG. 7 includes three phases: a measurement phase 702 (e.g., starting at time t₀ and ending at time t₃), a full duplex reuse polling phase 704 (e.g., starting at time t₃ and ending at time t₅), and a full duplex transmission phase 706 (e.g., starting at time t₅ and ending at time t₉). However, there may be some additional messages exchanged as part of the full duplex transmission session in other phases that are not shown in FIG. 7. As one example, some aspects may include a capability exchange phase before the measurement phase 702. The capability exchange phase may allow the AP to declare its support for a full duplex mode of operation, such as by including a full duplex support indicator in one or more messages sent to the STAs associated with the AP (or also STAs not yet associated with the AP). For example, the AP may include a full duplex support indicator in a beacon frame, a probe response message, trigger frame, a discovery frame, or another control frame. The capability exchange phase may also allow a STA to inform the AP of its transmission power used (e.g., for messages sent during the measurement phase 702), and/or inform the AP whether a given STA supports full duplex transmission polling. For example, the STA may send its capabilities in a trigger-based response message, a probe request, a discovery frame, or another control frame.

As another example, some aspects may include an acknowledgement phase after the full duplex transmission phase 706. During the acknowledgement phase, the AP, the STAs, or both may acknowledge reception of the various primary transmissions or reuse transmissions. In one example, because the reuse transmission(s) are considered a lower priority than the primary transmission(s) (e.g., reuse transmissions are delegated to a lower service class than the primary transmission), the reuse transmissions may not receive immediate acknowledgement messages as they may instead wait for the end of the TXOP associated with the primary transmission before the devices can send or receive acknowledgement messages.

In the measurement phase 702, the AP and one or more STAs may exchange request-to-send/clear-to-send (RTS/CTS) messages to reserve a TXOP for a primary transmission. For example, the AP may send an RTS message 708, e.g., at time t₁. In some aspects, time to and time ti may be the same time (not pictured). In response, the STA intended for the primary transmission (e.g., STA1 in this example) may send a CTS message 710 (e.g., at time t₂) back to the AP. In some aspects, the RTS message 708 may be configured to announce the potential coming of a full duplex reuse opportunity by including an indicator of the coming opportunity in the RTS message 708. Additionally, in some aspects where a downlink primary transmission is planned, the STA intended for the primary transmission may respond to the AP with a CTS only in the subchannel where the STA wants to receive the downlink primary transmission. For example, the STA may know that certain subchannels are experiencing more interference than other channels. When this occurs, the STA may select a favorable subchannel and send the CTS on that channel to indicate the subchannel preference to the AP so that the AP may use this subchannel for the upcoming downlink transmission.

The RTS message illustrated in FIG. 7 may be a single-user RTS message or may be a multi-user RTS message. When configured as a single-user RTS message, the message is addressed to STA1. When configured as a multi-user RTS message, the message is intended for a group of STAs. If a MU RTS message is used, the message may include a list of one or more STAs that are requested to perform a measurement during the measurement phase 702 (e.g., a measurement of the CTS message 710). For example, the MU RTS may include one or more user information fields that indicate which STAs are requested to measure the RSSI of the CTS message 710. The MU RTS may also indicate the channel width or location where the DL MU transmission will be localized (or the suggested channel for an UL transmission). In this example, if one or more STAs are not scheduled to generate the CTS message 710 for the measurement phase 702 and are not requested to measure a transmission characteristic of the CTS message 710, then those STAs may enter a sleep mode or doze state.

During the measurement phase 702, a STA that desires to participate in a reuse transmission, or participate in a full duplex transmission session hosted by the AP, may measure a transmission characteristic (e.g., received power level, RSSI value, etc.) associated with a transmission sent from another STA to the AP. For example, the measuring STA may measure a transmission characteristic associated with a transmission from a STA that will be involved in a future primary transmission. Specifically, in the example of FIG. 7, STA1 will be involved in an upcoming primary transmission and STA2-STA5 are possible candidates for a reuse transmission as part of a full duplex transmission session hosted by the AP. Thus, one or more of STA1-STA5 may be interested in measuring the CTS message 710 sent from STA1 so that STA1-STA5 may be able to determine if they qualify for the reuse transmission based on potential interference concerns. By measuring the received power level (e.g., RSSI) associated with the CTS message 710 when received at the measuring STA, the measuring STA may use this information (along with additional information from AP) to estimate the pass loss between the measuring STA and STA1 or otherwise make decisions regarding potential interference between a possible reuse transmission and the planned primary transmission. The measuring STA stores the measured transmission characteristic for use during later phases, such as the polling phase 704 and/or the transmission phase 706.

In the measurement phase 702 illustrated in FIG. 7, an RTS/CTS exchange is used to provide the measurement opportunity for the neighboring STAs. However, the RTS/CTS exchange is only one possible example option for the measurement phase 702. In other aspects, the neighboring STAs may measure a transmission characteristic (e.g., the received power level) of any type of transmission from the STA (e.g., STA1 in FIG. 7) that is designated as a participant in the upcoming primary transmission. In one specific alternative example, the AP may send a trigger frame to STA1 in place of the RTS message 708 (or in addition to the RTS message 708 in some aspects) during the measurement phase 702. The trigger frame may request STA1 to send a response message at a specific power level or at a maximum power level. The requested specific power level may be selected by the AP to achieve a certain target RSSI value. In response to the trigger frame, STA1 responds with a trigger-based Physical Layer Convergence Procedure (PLCP) Protocol Data Unit (PPDU) sent to the AP. STA1 may send the trigger-based PPDU in place of the CTS message 710 (or in addition to the CTS message 710 in some aspects). STA1 may include its transmission power level used for the trigger-based PPDU in the trigger-based PPDU, such as when STA1 uses a power level that is less than its maximum power level. The AP may then use this power level indication along with other data to set interference thresholds or help other STAs determine path loss characteristics between STA1 and other STAs. Other STAs that may want to join an upcoming full duplex transmission session hosted by AP may then measure a transmission characteristic associated with the trigger-based PPDU (e.g., a signal strength, a received power level, RSSI value, etc.).

After the measurement phase 702, the devices may enter the polling phase 704 (e.g., at time t₃). During the polling phase 704, the AP determines if any STAs are interested in participating in a reuse transmission that at least partially overlaps with the planned primary transmission. For example, the AP determines whether any STAs are interested in participating in a full duplex session hosted by the AP that involves STA1 and one or more other STAs. To initiate the polling phase 704, the AP may send a polling message to a group of one or more STAs. In one example, the AP sends a null data packet (NDP) feedback (FB) trigger message 712 (e.g., at time t₃) to a group of one or more STAs. In some aspects, the NDP FB trigger message 712 may initiate (“trigger”) the polling phase 704. In another example, the AP sends a polling frame or a different type of trigger frame to illicit a polling response (e.g., a TB PPDU) from one or more STAs.

In addition to standard trigger frame content, the NDP FB trigger message 712 used in the polling phase 704 may also include information relevant to qualification of a STA for participation in an upcoming full duplex transmission session hosted at the AP. In one example, the NDP FB trigger message 712 includes an interference threshold. The interference threshold may be an uplink full duplex reuse threshold that is usable by STAs to determine qualification for an upcoming uplink reuse transmission opportunity. The candidate STAs may use this threshold in combination with the data collected during the measurement phase 702 (e.g., the CTS RSSI or other received power measurement) to determine whether to participate in the reuse transmission. The AP may set the interference threshold included in the NDP FB trigger message 712 to a level based on a calculation that depends on a tolerable interference level at STA1 and a transmission power used by STA1 for the measurement message (e.g., CTS message 710 in FIG. 7). In one example, the AP calculates the threshold as: FDReuseThr=Intf_{Threshold}+CTS_{TxPwr_STA1}, where FDReuseThr represents the threshold value sent from the AP to the candidate STAs, Intf_{Threshold} represents a tolerable interference level at STA1, and CTS_{TxPwr_STA1} represents the power level used by STA1 to transmit the CTS message 710. The AP may also adjust the threshold (FDReuseThr) by adding a certain margin of error to the threshold value to cover possible inaccuracy of transmission power and receive power measurements.

The NDP FB trigger message 712 may also include a buffer status requirement. The buffer status requirement may provide a threshold level of buffered data that may be needed for a STA to qualify for participation in the reuse transmission. For example, the AP may wish to limit reuse transmissions to situations where a STA has enough data ready to be sent to transmit to justify the potential interference that the reuse transmission could cause to the primary transmission. The buffer status requirement may be a binary indication (e.g., either the STA has data, or the STA does not have data) or may be a dynamic, changeable, or customizable level set by the AP related to a minimum transmission queue size at a STA. Similarly, the NDP FB trigger message 712 may specify an access class requirement. For example, the AP may limit reuse transmissions only to STAs that have a high enough access class to allow participation.

After a STA or group of STAs receives the NDP FB trigger message 712, the STA(s) determine eligibility (e.g., qualification) for the potential reuse transmission. For example, the STA may test one or more of the following requirements if specified (e.g., by the AP) in the full duplex transmission session example: the interference requirements (if any), the target RSSI requirements (if any), the buffer status requirements (if any), the access class requirements (if any), and/or the clear channel assessment (CCA) requirements (if any). The STA will determine if it is eligible for participation in the reuse transmission after considering this data.

Regarding the interference requirements, in one example, the STA may compute its transmission power (TxPwrₙ) based on a power control scheme using a target RSSI and trigger frame transmission power information provided in the trigger frame. The STA may then check if the computed TxPwrₙ satisfies the following condition:

TxPwrₙ+CTS_{RSSI}_{ₙ}≤FDResuseThr=Intf_{Threshold}+CTS_{TxPwr}_{_{STA1′}}

where CTS_{RSSI_n} represents the measured power level of the CTS message 710 sent by STA1 when it is received at the subject STA (e.g., STA2 or another STA), FDReuseThr represents an interference threshold, Intf_{Threshold} represents an allowable level of interference at the STA involved in the primary transmission, and CTS_{TxPwr_STA1} represents the power used by STA1 to transmit the CTS message 710. The AP may send the interference threshold (FDReuseThr) to the STAs in the NDP FB trigger message 712 or any other message. Alternatively, the AP may send other data related to setting an acceptable interference level. For example, the AP may send the Intf_{Threshold} and/or the CTS_{TxPwr_STA1} which would allow the STA to make qualification decisions regarding the reuse transmission. The discussion of FIG. 2A above provides some additional details regarding the interference qualifications and exchange of interference information between devices.

If eligible for participation in the reuse transmission, then the STA will send a message back to the AP including a request to participate in the reuse transmission. For example, the STA may send an NDP FB message to the AP in response to the NDP FB trigger message 712. In the example of FIG. 7, STA2 determines that it qualifies and would like to participate in the reuse transmission and thus sends the NDP FB message 714 to the AP (e.g., at time t₄), STA3 determines that it qualifies and would like to participate in the reuse transmission and thus sends the NDP FB message 716 (e.g., at time t₄) to the AP, STA4 determines that it qualifies and would like to participate in the reuse transmission and thus sends the NDP FB message 718 (e.g., at time t₄) to the AP, and STA5 determines that it does not satisfy one or more of the qualification requirements and thus does not send any response back to the AP. In any given aspect, zero or more STAs may respond to the AP and request participation in the upcoming reuse transmission opportunity. In some aspects, one or more of the NDP FB message 714, the NDP FB message 716, and the NDP FB message 718 may be sent at a time other than t₄ (not pictured) during the polling phase 704.

After the polling phase 704, the devices may enter the transmission phase 706 (e.g., at time t₅). In the transmission phase 706 the AP may coordinate overlapping uplink and downlink transmissions as part of the full duplex transmission session hosted at the AP. In the example of FIG. 7, the primary transmission is a downlink transmission 728 sent from the AP to STA1 (e.g., at time t₇), and the reuse transmissions include an uplink transmission 722 sent from STA2 to the AP (e.g., at time t₇), an uplink transmission 724 sent from STA3 to the AP (e.g., at time t₇), and an uplink transmission 726 sent from STA4 to the AP (e.g., at time t₈). In other aspects, the reuse transmission may be only one single user uplink transmission or may include additional transmissions as part of one or more multi-user transmissions. In some aspects, one or more of the downlink transmission 728, the uplink transmission 722, and the uplink transmission 724 may be sent at a time other than t₇ (not pictured) during the transmission phase 706.

In one example, the AP may initiate the uplink reuse transmissions 722, 724, and 726 by sending one or more trigger messages 720 (e.g., at time t₆) to STA2, STA3, and STA4. The trigger message 720 provides a schedule for the uplink reuse transmissions 722, 724, and 726. The uplink reuse transmissions 722, 724, and 726 may be scheduled to end no later than the end of the transmission opportunity (e.g., at time t₉) reserved for the primary transmission 728. Also, the uplink reuse transmission may not receive an acknowledgment message immediately after completing the transmission. For example, STA2 and STA3 may need to wait until after the primary transmission 728 has completed before receiving an acknowledgement message in response to the uplink reuse transmissions 722 and 724.

When multiple uplink reuse transmissions are planned, the trigger message 720 may schedule each uplink reuse transmission to start at the same time. Alternatively, the trigger message 720 may be enhanced to support staggered starting times and to support TDMA of multiple STAs. When the trigger message 720 supports staggered starting times, the trigger message 720 may explicitly specify the starting time for each trigger-based uplink PPDU. The starting time may be expressed as an offset to the end of the trigger frame (instead of using a default Short Interframe Space (SIFS) time interval after the trigger frame for all triggered transmissions). In the example of FIG. 7, uplink reuse transmissions 722 and 724 are triggered to start at a first time (e.g., SIFS after the end of the trigger frame 720), which is the same starting time as the primary downlink transmission 728, and the uplink transmission 726 is triggered to start at a later time that is delayed relative to the start time of uplink transmissions 722 and 724. In various aspects, the primary transmission 728 and the reuse transmissions 722, 724, and 726 may start at the same time (e.g., SIFS after the end of the trigger frame 720) or may start at different times. In one example, a reuse transmission may be scheduled to start earlier than the primary transmission by the duration of the legacy preamble to increase the chance of the legacy length preamble field of the reuse transmission being decoded correctly by surrounding STAs.

In some aspects, the trigger frame 720 may provide a list of one or more STAs scheduled for the primary transmission 728. A STA that is not included in the list, and does not intend to participate in a reuse transmission, may elect to move into a sleep state for the rest of the following PPDU or TXOP. If a STA is included in the list (e.g., by inclusion of its association identification (AID) value in the trigger frame list), then the trigger frame may provide an early signal to the STA as to where the primary transmission is going to occur. Additionally, in an aspect, the AP itself could act as a virtual STA contributing in the trigger-based PPDU creation with the intended recipients being provided in the trigger frame itself.

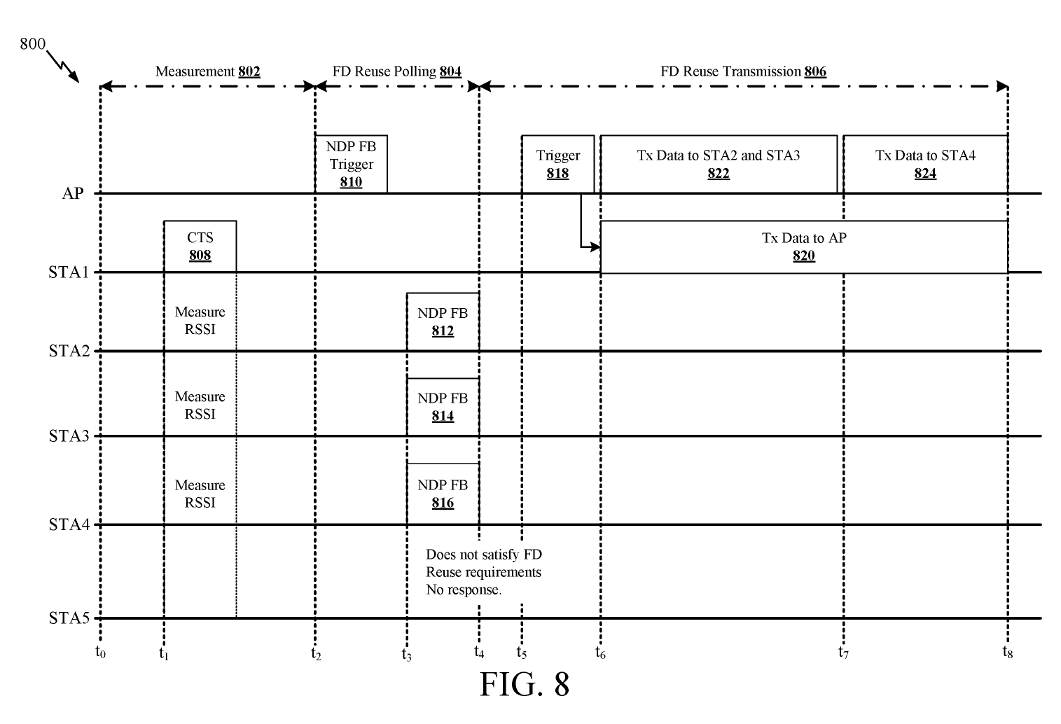

FIG. 8 is a message exchange diagram 800 for establishing a downlink reuse transmission as part of a full duplex transmission session. In the example of FIG. 8, the system includes an AP and multiple STAs (STA1-STA5). Other aspects may include any number of one or more STAs, may include multiple APs, or may include a STA acting as the AP in the message flow of FIG. 8. The setup of the full duplex transmission session of FIG. 8 includes three phases: a measurement phase 802 (e.g., starting at time t₀ and ending at time t₂), a full duplex reuse polling phase 804 (e.g., starting at time t₂ and ending at time t₄), and a full duplex transmission phase 806 (e.g., starting at time t₄ and ending at time t₈). However, there may be some additional messages exchanged as part of the full duplex transmission session in other phases that are not shown in FIG. 8. For example, some aspects may include a capability exchange phase before the measurement phase 802 and/or an acknowledgment phase after the transmission phase 806, as described in more detail above in connection with FIG. 7.

In the measurement phase 802, STA1 may send any message to provide an interference measurement opportunity for neighboring STAs. The transmission from STA1 may be sent from STA1 in response to a trigger message sent by the AP, may be part of an RTS/CTS exchange, may be a control frame or data frame, or may be any other part of a transmission sequence between STA1 and the AP. In the example of FIG. 8, STA1 sends a CTS message 808 to the AP (e.g., at time t₁) to reserve a TXOP for a primary uplink transmission from STA1 to the AP. In some aspects, time t₀ and time t₁ may be the same time (not pictured). A STA that desires to participate in a full duplex transmission session hosted by the AP (e.g., to participate in a downlink reuse transmission that at least partially overlaps with the planned primary uplink transmission) may measure a transmission characteristic (e.g., received power level, RSSI value, etc.) associated with a transmission sent from STA1. Further details of the measurement phase are discussed above in connection with FIG. 7 and apply to the measurement phase 802 of FIG. 8 as well.

After the measurement phase 802, the devices may enter the polling phase 804 (e.g., at time t₂). During the polling phase 804, the AP determines if any STAs are interested in participating in a reuse transmission that at least partially overlaps with the planned primary transmission. For example, the AP determines whether any STAs are interested in participating in a full duplex session hosted by the AP that involves STA1 and one or more other STAs. In the context of FIG. 8, the reuse transmission is a downlink transmission from the AP to the participating STA(s). To initiate the polling phase 804, the AP may send a polling message to a group of one or more STAs. In one example, the AP sends a null data packet (NDP) feedback (FB) trigger message 810 to a group of one or more STAs (e.g., at time t₂). In another example, the AP sends a polling frame or a different type of trigger frame to illicit a polling response (e.g., a TB PPDU) from one or more STAs. In some aspects, the NDP FB trigger message 810 may initiate (“trigger”) the polling phase 804.

In addition to standard trigger frame content, the NDP FB trigger message 810 used in the polling phase 804 may also include information relevant to qualification of a STA for participation in an upcoming full duplex transmission session hosted at the AP. In one example, the NDP FB trigger message 810 includes an identification of the STA that is scheduled to participate in the primary transmission. In the example of FIG. 8, the NDP FB trigger message 810 would include an identifier (e.g., AID) of STA1 so that the other STAs are able to determine which STA is relevant for interference determinations and reuse qualification purposes.

The NDP FB trigger message 810 may also include an interference threshold. The interference threshold may be a downlink full duplex reuse threshold that is usable by STAs to determine qualification for an upcoming downlink reuse transmission opportunity. The candidate STAs may use this threshold in combination with the data collected during the measurement phase 802 (e.g., the CTS RSSI or other received power measurement) to determine whether to participate in the reuse transmission. The AP may set the interference threshold included in the NDP FB trigger message 810 to a level based on a calculation that depends on a tolerable interference level at STA1 and a transmission power used by STA1 for the measurement message (e.g., CTS message 808 in FIG. 8). In one example, the AP calculates the threshold as: FDReuseThr=Intf_{Threshold}+CTS_{Txpwr_STA1}, where FDReuseThr represents the threshold value sent from the AP to the candidate STAs, Intf_{Threshold} represents a tolerable interference level at STA1, and CTSTxPwr_{STA1} represents the power level used by STA1 to transmit the CTS message 710. The AP may also adjust the threshold (FDReuseThr) by adding a certain margin of error to the threshold value to cover possible inaccuracy of transmission power and receive power measurements.

After a STA or group of STAs receives the NDP FB trigger message 810, the STA(s) determine eligibility (e.g., qualification) for the potential reuse transmission. For example, the STA may check one or more of the following requirements if specified (e.g., by the AP) in the full duplex transmission session example: the interference requirements (if any), the target RSSI requirements (if any), the access class requirements (if any), and/or the clear channel assessment (CCA) requirements (if any). The STA will determine if it is eligible for participation in the reuse transmission after considering this data.

Regarding the interference requirements, in one example, the STA determining qualification for the reuse transmission may compare the measured transmission characteristic (e.g., RSSI, etc.) associated with the received transmission from STA1 (the participant in the upcoming primary transmission) against the interference threshold provided by the AP in the NDP FB trigger message 810. If the measured RSSI level (or alternative potential interference measurement used by the devices) is less than or equal to the interference threshold, then the STA may qualify for the upcoming reuse transmission opportunity assuming other qualification tests (e.g., CCA) are passed.

If eligible for participation in the reuse transmission, then the STA will send a message back to the AP including a request to participate in the reuse transmission. For example, the STA may send an NDP FB message to the AP in response to the NDP FB trigger message 810. In the example of FIG. 8, STA2 determines that it qualifies and would like to participate in the reuse transmission and thus sends the NDP FB message 812 to the AP (e.g., at time t₃), STA3 determines that it qualifies and would like to participate in the reuse transmission and thus sends the NDP FB message 814 to the AP (e.g., at time t₃), STA4 determines that it qualifies and would like to participate in the reuse transmission and thus sends the NDP FB message 816 to the AP (e.g., at time t₃), and STA5 determines that it does not satisfy one or more of the qualification requirements and thus does not send any response back to the AP. In any given aspect, zero or more STAs may respond to the AP and request participation in the upcoming reuse transmission opportunity. In some aspects, one or more of the NDP FB message 812, the NDP FB message 814, and the NDP FB message 816 may be sent at a time other than t₃ (not pictured) during the polling phase 804.

As an alternative example to the NDP FB trigger message 810 and NDP FB message 812, 814, and 816 exchange sequence, the devices may use alternative message formats. For example, the AP could send a trigger message to illicit a trigger-based PPDU back from the STAs of interest. The trigger message could include an identification of the STA that will participate in the primary transmission (e.g., the AID of STA1). The trigger-based PPDU sent back to the AP could include the measured transmission characteristic (e.g., RSSI) associated with the STA that will participate in the primary transmission. The AP may receive back multiple trigger-based PPDUs that include multiple different measured transmission characteristics (e.g., RSSI of STA1 transmission as measured by STA2, RSSI of STA1 transmission as measured by STA3, etc.). The AP may then be able to use this feedback information regarding the measured transmission characteristic to decide on its own whether to initiate a downlink reuse transmission to any of the STAs that sent back a trigger-based PPDU during the polling phase 804. The AP may also use this feedback information regarding the measured transmission characteristic to customize its own transmission characteristics, such as setting the MCS to the desired level, choosing an appropriate number of spatial streams, choosing a transmission power, or other transmission characteristics. The AP may dynamically set its transmission characteristics for the reuse transmission(s) in effort to satisfy an interference threshold related to qualification of a reuse transmission to at least partially overlap with a primary transmission.

After the polling phase 804, the devices may enter the transmission phase 806 (e.g., at time t₄). In the transmission phase 806 the AP may coordinate overlapping uplink and downlink transmissions as part of the full duplex transmission session hosted at the AP. In the example of FIG. 8, the primary transmission is an uplink transmission 820 sent from STA1 to the AP (e.g., at time t₆), and the reuse transmissions include a downlink transmission 822 sent from the AP to STA2 and STA3 (e.g., a multi-user DL PPDU) (e.g., at time t₆), and a downlink transmission 824 sent from the AP to STA4 (e.g., a single-user DL PPDU) (e.g., at time t₇). In other aspects, the reuse transmission(s) may include only one single user downlink transmission, multiple single-user downlink transmission, or may include one or more multi-user transmissions. In some aspects, one or both of the downlink transmission 822 and the uplink transmission 820 may be sent at a time other than t₆ (not pictured) during the transmission phase 806.

In one example, the AP may initiate the uplink primary transmission 820 by sending a trigger message 818 to STA1 (e.g., at time t₅). In some aspects, time t₄ and time t₅ may be the same time (not pictured). The trigger message 720 provides a schedule for the uplink primary transmission 820. The downlink reuse transmissions 822 and 824 may be scheduled to end no later than the end of the transmission opportunity reserved for the primary transmission 820. Also, one or more of the downlink reuse transmissions may not receive an acknowledgment message immediately after completing the transmission. For example, the AP may need to wait until after the primary transmission 820 has completed before receiving an acknowledgement message in response to the downlink reuse transmission 822. Additionally, the uplink primary transmission 820 and a downlink reuse transmission may be aligned to have a common starting time (e.g., SIFS after the end of trigger frame 818) or may be staggered to start at different times (e.g., as shown when comparing the starting time of primary transmission 820 and reuse transmission 824).

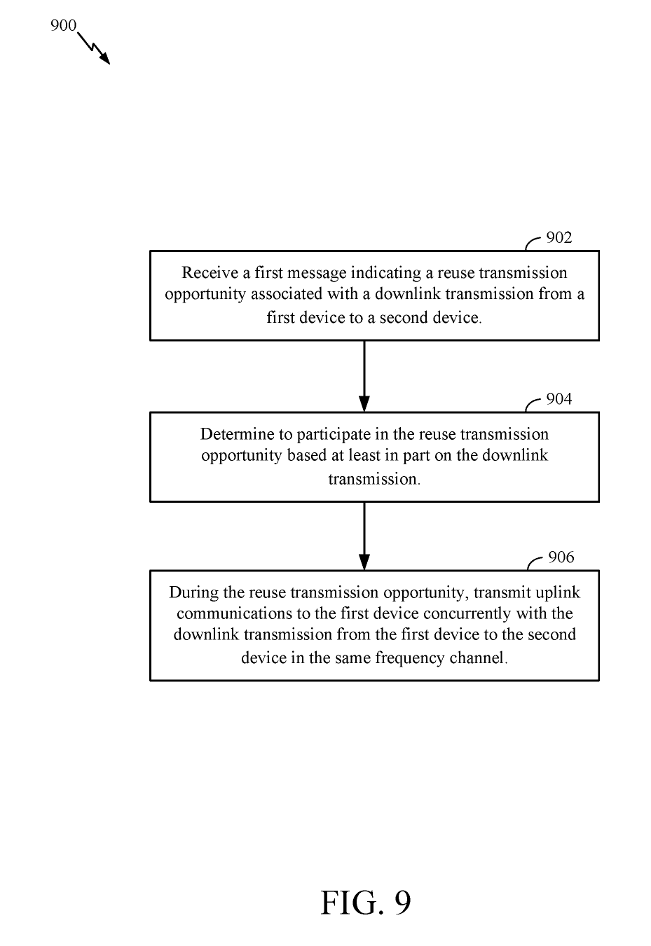

FIG. 9 is a flow diagram illustrating an example process 900 for wireless communication according to some aspects. In some aspects, the process 900 may be performed by a STA (e.g., the STA2 115-b of FIG. 2A).

Referring to 902, the STA2 may receive a first message indicating a reuse transmission opportunity associated with a downlink transmission from a first device to a second device. In some aspects, the first device may be an AP (e.g., the AP 105-a of FIG. 2A), and the second device may be another STA (e.g., STA1 115-a of FIG. 2A).

Referring to 904, the STA2 may determine to participate in the reuse transmission opportunity based at least in part on the downlink transmission.

Referring to 906, during the reuse transmission opportunity, the STA2 may transmit uplink communications to the first device concurrently with the downlink transmission from the first device to the second device in the same frequency channel.

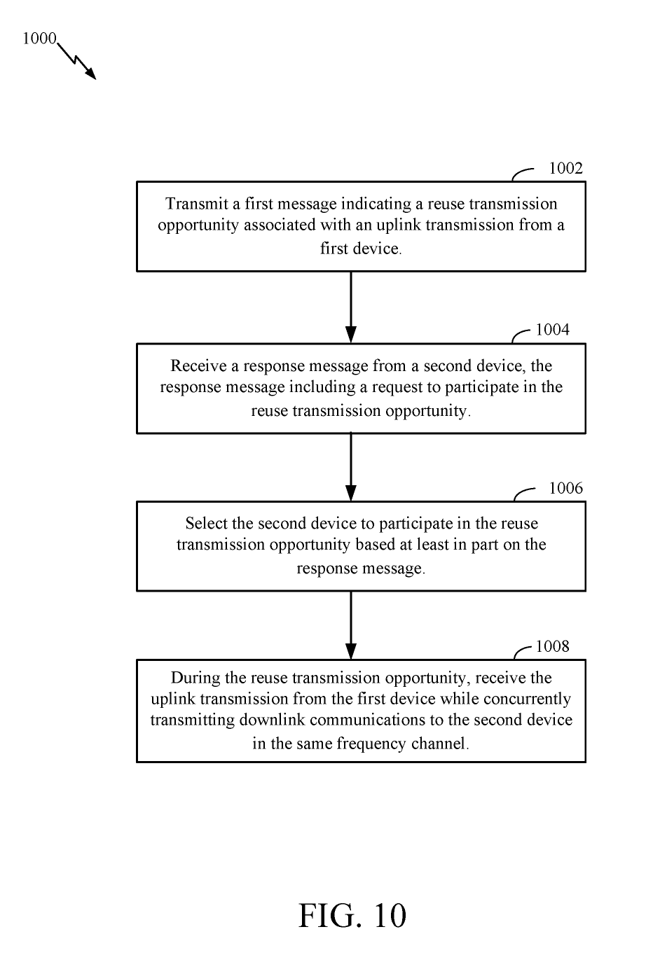

FIG. 10 is a flow diagram illustrating another example process 1000 for wireless communication according to some aspects. In some aspects, the process 1000 may be performed by an AP (e.g., the AP 105-a of FIG. 2B).

Referring to 1002, the AP may transmit a first message indicating a reuse transmission opportunity associated with an uplink transmission from a first device. In some aspects, the first device may be a STA (e.g., the STA1 115-a of FIG. 2B).

Referring to 1004, the AP may receive a response message from a second device, the response message including a request to participate in the reuse transmission opportunity. In some aspects, the second device may be another STA (e.g., the STA2 115-b of FIG. 2B).

Referring to 1006, the AP may select the second device to participate in the reuse transmission opportunity based at least in part on the response message.

Referring to 1008, during the reuse transmission opportunity, the AP may receive the uplink transmission from the first device while concurrently transmitting downlink communications to the second device in the same frequency channel.

The various illustrative components, logic, logical blocks, modules, circuits, operations and algorithm processes described in connection with the aspects disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes, operations and methods may be performed by circuitry that is specific to a given function.

As described above, in some aspects the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the aspects described in this disclosure may be readily apparent to persons having ordinary skill in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, various features that are described in this specification in the context of separate aspects also can be implemented in combination in a single implementation. Conversely, various features that are described in the context of a single aspect also can be implemented in multiple implementations separately or in any suitable sub-combination. As such, although features may be described above as acting in particular combinations, and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the aspects described above should not be understood as requiring such separation in all implementations, and it should be understood that the described program components and systems can generally be integrated together in a single software product or packaged into multiple software products.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on. Furthermore, although certain aspects may be described or claimed in the singular, the plural is contemplated unless limitation to the singular is explicitly stated.

What is claimed is:

1. A method for wireless communication, comprising:
receiving a first message indicating a reuse transmission opportunity associated with a downlink transmission from a first device to a second device;
determining to participate in the reuse transmission opportunity based at least in part on the downlink transmission; and
during the reuse transmission opportunity, transmitting uplink communications to the first device concurrently with the downlink transmission from the first device to the second device in the same frequency channel.

2. The method of claim 1, the method further comprising:
receiving, from the first device, a trigger frame for scheduling transmission of the uplink communications.

3. The method of claim 1, the method further comprising:
measuring a received signal strength associated with a first transmission from the second device to the first device, wherein the determining comprises determining to participate in the reuse transmission opportunity based at least in part on the measured received signal strength.

4. The method of claim 3, wherein the received signal strength comprises an amount of received power from the first transmission, wherein the determining further comprises comparing the amount of received power with a threshold included in the first message, and wherein the threshold is based on an amount of interference tolerable to the second device and a transmission characteristic of the second device.

5. The method of claim 4, wherein the determining further comprises determining a first transmission power based on the first message and comparing the first transmission power and the amount of received power with the threshold.

6. The method of claim 1, wherein the first message includes a buffer status level, and wherein the determining comprises determining that an amount of data to be transmitted to the first device exceeds the buffer status level.

7. The method of claim 1, the method further comprising:
transmitting, to the first device, a second message indicating the participation in the reuse transmission opportunity.

8. The method of claim 1, wherein the first message polls one or more devices to participate in the reuse transmission opportunity.

9. The method of claim 1, wherein more than one device participates in the reuse transmission opportunity.

10. The method of claim 1, wherein the downlink transmission is assigned to a first service class and the uplink communications are assigned to a second service class, the method further comprising:
receiving an acknowledgement of the uplink communications after a transmission of an acknowledgement of the downlink transmission based on the second service class having a lower priority than the first service class.

11. The method of claim 1, wherein the first message initiates a reuse polling phase that occurs before the reuse transmission opportunity, the method further comprising:
transmitting a second message to the first device in response to receiving the first message.

12. The method of claim 11, wherein the first message comprises a null data packet (NDP) feedback (FB) trigger message that includes an identifier of the second device, and wherein the second message comprises a trigger-based feedback NDP physical layer convergence procedure (PLCP) protocol data unit (PPDU).

13. The method of claim 1, the method further comprising:
receiving a trigger message from the first device that includes a first time for transmitting the uplink communications and a second time, different than the first time, for another device to transmit second uplink communications to the first device.

14. A wireless device, comprising:
one or more processors; and
a memory storing processor-readable instructions that, when executed by the one or more processors, causes the wireless device to perform operations comprising:
receiving a first message indicating a reuse transmission opportunity associated with a downlink transmission from a first device to a second device;
determining to participate in the reuse transmission opportunity based at least in part on the downlink transmission; and
during the reuse transmission opportunity, transmitting uplink communications to the first device concurrently with the downlink transmission from the first device to the second device in the same frequency channel.

15. The wireless device of claim 14, the operations further comprising:
receiving, from the first device, a trigger frame for scheduling transmission of the uplink communications.

16. The wireless device of claim 14, wherein the first message includes a buffer status level, and wherein the determining comprises determining that an amount of data to be transmitted to the first device exceeds the buffer status level.

17. The wireless device of claim 14, the operations further comprising:
transmitting, to the first device, a second message indicating the participation in the reuse transmission opportunity.

18. The wireless device of claim 14, wherein the first message polls one or more devices to participate in the reuse transmission opportunity.

19. The wireless device of claim 14, wherein more than one device participates in the reuse transmission opportunity.

20. The wireless device of claim 14, wherein the downlink transmission is assigned to a first service class and the uplink communications are assigned to a second service class, the operations further comprising:
receiving an acknowledgement of the uplink communications after a transmission of an acknowledgement of the downlink transmission based on the second service class having a lower priority than the first service class.

21. A method for wireless communication, comprising:
transmitting a first message indicating a reuse transmission opportunity associated with an uplink transmission from a first device;
receiving a response message from a second device, the response message including a request to participate in the reuse transmission opportunity;
selecting the second device to participate in the reuse transmission opportunity based at least in part on the response message; and
during the reuse transmission opportunity, receiving the uplink transmission from the first device while concurrently transmitting downlink communications to the second device in the same frequency channel.

22. The method of claim 21, further comprising:
transmitting, to the first device, a trigger frame for scheduling the uplink transmission.

23. The method of claim 21, wherein the first message includes an identifier of the first device and an interference threshold for the first device, and wherein receiving the response message is based at least in part on a comparison between a received signal strength for the second device and the interference threshold.

24. The method of claim 21, wherein the first message polls one or more devices to participate in the reuse transmission opportunity.

25. The method of claim 21, wherein the downlink communications are transmitted to one or more devices in addition to the second device.

26. A wireless device, comprising:
one or more processors; and
a memory storing processor-readable instructions that, when executed by the one or more processors, causes the wireless device to perform operations comprising:
transmitting a first message indicating a reuse transmission opportunity associated with an uplink transmission from a first device;
receiving a response message from a second device, the response message including a request to participate in the reuse transmission opportunity;
selecting the second device to participate in the reuse transmission opportunity based at least in part on the response message; and
during the reuse transmission opportunity, receiving the uplink transmission from the first device while concurrently transmitting downlink communications to the second device in the same frequency channel.

27. The wireless device of claim 26, the operations further comprising:
transmitting, to the first device, a trigger frame for scheduling the uplink transmission.

28. The wireless device of claim 26, wherein the first message includes an identifier of the first device and an interference threshold for the first device, and wherein receiving the response message is based at least in part on a comparison between a received signal strength for the second device and the interference threshold.

29. The wireless device of claim 26, wherein the first message polls one or more devices to participate in the reuse transmission opportunity.

30. The wireless device of claim 26, wherein the downlink communications are transmitted to one or more devices in addition to the second device.
